(19) United States
(12) Patent Application Publication
(10) Pub. No.: US 2004/0106436 A1
(43) Pub. Date: Jun. 3, 2004

(54) Wireless LAN technologies for reducing interference between or among wireless LAN access points

(75) Inventors: Ryoichi Ochi, Kawasaki-Shi (JP); Yoshikazu Kabayashi, Kawasaki-Shi (JP)

Correspondence Address: YOUNG & THOMPSON, 745 SOUTH 23RD STREET 2ND FLOOR, ARLINGTON, VA, 22202

(73) Assignee: NEC INFRONTIA CORPORATION, KAWASAKI-SHI (JP)

(21) Appl. No.: 10/694,768

(22) Filed: Oct. 29, 2003

(30) Foreign Application Priority Data
Nov. 28, 2002 (JP) 2002-344762

(51) Int. Cl. H04M 1/00

(52) U.S. Cl. 455/562.1; 455/575.7; 455/426.2

(57) ABSTRACT

A wireless LAN technology for reducing interference between (or among) wireless LAN access points is provided. A wireless LAN access point is provided with a directional antenna, an interference detector detecting interference effected by another wireless LAN access point on the directional antenna, and a direction adjusting mechanism adjusting a maximum gain direction of the directional antenna in response to the detected interference.

### BACKGROUND OF THE INVENTION

1. Field of the Invention

The present invention is related, in general, to a wireless LAN (local area network) technologies, in particular, to techniques for reducing interference between or among wireless LAN access points.

2. Description of the Related Art

Wireless LAN is one of the promising technologies for building computer networks. Wireless LAN technologies effectively improves flexibility of node arrangements of computer networks. In addition, wireless LAN technologies is suited for providing connections to the Internet for individual's terminals in a public environment. These advantages promote use of wireless LAN technologies.

Wireless LAN technologies involve wireless LAN access points (which functions as mother stations) and wireless LAN adapters (which functions as daughter terminals). Wireless LAN adapters are installed within user computers to provide accesses to a LAN for the user computers. Communications between wireless LAN access points and adapters are achieved in accordance with the IEEE 802.11 protocols standardized by IEEE 802.11 Committee.

Communications between wireless LAN access points and adapters, that is, communications in accordance with the IEEE 802.11 protocols suffer from reduced number of communication channels because of limitation of frequency resources. Although the IEEE 802.11 protocols allows use of 14 channels, the number of effective channels are less than 14. The reason is that the use of channels adjacent in frequency at the same time is prohibited, because the difference in the adjacent frequencies is too small. In Japan, for example, the frequencies allocated to the wireless LAN technologies ranges between 2.412 to 2.482 GHz, and this implies that frequency difference of the adjacent channels to be as small as 5 MHz. This undesirably reduces the number of effective channels of wireless LAN technologies.

The reduced number of effective channels often causes interference among wireless LAN access points, especially in regions where a lot of wireless LAN access points are located. Interference among wireless LAN access points may result in communication errors, such as noises, loss of data, and interruption of communications in the worst case. Therefore, avoiding interference is of importance for wireless LAN technologies.

Japanese Unexamined Patent Application No. Jp-A-Heisei 8-84148 discloses a wireless LAN system for reducing interference among stations. The disclosed wireless LAN system is composed of mother terminals provided with omnidirectional antennas, and daughter terminals provided with directional antennas. The main lobe axis of the directional antenna of each daughter terminal is directed in the direction from the daughter terminal to the associated mother terminal. This avoids emanation of wave from the daughter terminals in undesirable directions, and effectively reduces interference.

Although the disclosed wireless LAN system is effective for reducing interference between or among daughter stations, this system is not effective for reduction of interference among mother stations (that is, wireless LAN access points).

Another wireless LAN system for avoiding interference between or among wireless LAN access points is disclosed in Japanese Unexamined Patent Application No. P2002-217917A. In the disclosed system, daughter stations develop broadcast signals on a broadcast signal channel to provide information on the communication channels. When a wireless LAN access point is newly installed within the system, the newly installed wireless LAN access point receives the broadcast signals and selects two of the communication channels. One of the selected communication channels is used as its communication channel, and the other is used to transmit broadcast signals.

A base station antenna system for avoiding phasing caused by multipath problems, and also improving the gain for the desired wave is disclosed in Japanese Unexamined Patent Application No. P2000-252734. The disclosed system includes first and second sets of omnidirectional antennas, and synthesizes signals from the antennas to reproduce a desired signal. The second sets of the antennas are located around the first sets of the antennas. This architecture allows the distance between the antennas used for space diversity to be variable. This effectively improves the gain for the desired wave while reducing influences of phasing.

### SUMMARY OF THE INVENTION

An object of the present invention is to provide a technique for an improvement in interference reduction between or among wireless LAN access points.

Another object of the present invention is to provide a technique for achieving enlarged communicable areas while reducing interference between or among wireless LAN access points.

In an aspect of the present invention, a wireless LAN access point is provided with a directional antenna, an interference detector detecting interference effected by another wireless LAN access point on the directional antenna, and a direction adjusting mechanism adjusting a maximum gain direction of the directional antenna in response to the detected interference.

In the event that the wireless LAN access point is provided with a control unit determining an optimized direction in response to the detected interference, and the direction adjusting mechanism adjusts a maximum gain direction of the directional antenna to the optimized direction, the control unit preferably determines the optimized direction such that the directional antenna is free from the interference effected by the other wireless LAN access point.

When the interference detector detects a strength of the interference from the other wireless LAN access points, the controller unit preferably determines the optimized direction in response to the detected strength of the interference.

In another aspect of the present invention, a wireless LAN access point is composed of a directional antenna, an omnidirectional antenna, a signal processor, a selector unit selecting one of the directional antenna and the omnidirectional antenna in response to an interference from other wireless LAN access points. The selector unit provides electrical connections between the signal processor and the selected antenna, and the signal processor receives and transmits radio signals through the selected antenna.

When the wireless LAN access point preferably includes an interference detector detecting the interference, it is advantageous if the selector unit, in response to detection of the interference during reception and transmission of the radio signals through the omnidirectional antenna, disconnects the omnidirectional antenna from the signal processor, and connects the directional antenna to the signal processor.

In this case, the wireless LAN access point preferably includes a controller unit determining an optimized direction in response to a strength of the interference, and a direction adjusting mechanism adjusting an maximum gain direction of the directional antenna to the optimized direction.

In still another aspect of the present invention, a wireless LAN access point is composed of a plurality of directional antennas having different maximum gain directions, an antenna controller adapted to activate and deactivate the plurality of directional antennas; and an interference detecting unit detecting interference effected by other wireless LAN access point on the plurality of directional antennas. The antenna controller deactivates one of the plurality of directional antennas on which the interference is effected, while activating another of the plurality of directional antennas which is free from the interference.

In still another aspect of the present invention, a wireless LAN system is composed of a plurality of wireless LAN access points, and an antenna controller. Each of the wireless LAN access points includes a directional antenna, and a direction adjusting mechanism connected to the directional antenna. The antenna controller determines an optimum direction of each of the directional antennas. Each of the direction adjusting mechanisms adjusts a maximum gain direction of the directional antennas associated therewith to the optimum direction determined by the antenna controller.

The antenna controller preferably determines the optimum directions of the directional antennas such that communicable areas of the plurality of wireless LAN access points do not overlap one another.

In still another aspect of the present invention, a wireless LAN access point is composed of an interference detector detecting interference effected by other wireless LAN access points, a channel selector switching a plurality of channels used to communicate with a terminal, and a signal processor. The channel selector selects, in response to detection of interference on one of the plurality of channels during communications through the one channel, another channel from among the plurality of channels which receives least interference from the other wireless LAN access points. The signal processor communicates with the terminal through the selected channel.

In still another aspect of the present invention, a method for avoiding interference between wireless LAN access points is composed of:

detecting interference between first and second wireless LAN access points, and

moving an electromagnetic shield between the first and second wireless LAN access points in response to occurrence of the interference.

In the case when the electromagnetic shield includes a shield plate, the method is preferably further composed of:

arranging the shield plate such that a main surface of the shield plate is parallel to a direction of an electromagnetic wave from the first wireless LAN access point in response to nonoccurrence of the interference.

In this case, it is also preferably that the method is further composed of:

laying down the shield plate onto a floor in response to nonoccurrence of the interference.

### BRIEF DESCRIPTION OF THE DRAWINGS

FIG. 1 is a schematic illustrating a structure of a wireless LAN access point in a first embodiment;

FIG. 2 is a block diagram of the wireless LAN access point in the first embodiment;

FIG. 3 schematically illustrates an operation of the wireless LAN access point in the first embodiment;

FIG. 4 is a schematic illustrating a structure of a wireless LAN access point in a second embodiment;

FIG. 5 is a block diagram of the wireless LAN access point in the second embodiment;

FIG. 6 is a block diagram of a wireless LAN access point in a third embodiment;

FIGS. 7A and 7B schematically illustrate an operation of the wireless LAN access point in the third embodiment;

FIG. 8 is a schematic illustrating a wireless LAN system in a fourth embodiment;

FIGS. 9A and 9B schematically illustrate an operation of the wireless LAN system in the fourth embodiment;

FIGS. 10A and 10B are schematics illustrating a wireless LAN system in a fifth embodiment;

FIG. 11 is a block diagram of a wireless LAN access point in a sixth embodiment; and

FIG. 12 is a flowchart illustrating an operation of the wireless LAN access point in the sixth embodiment.

### DESCRIPTION OF THE PREFERRED EMBODIMENTS

Preferred embodiments of the present invention are described below in detail with reference to the attached drawings.

### FIRST EMBODIMENT

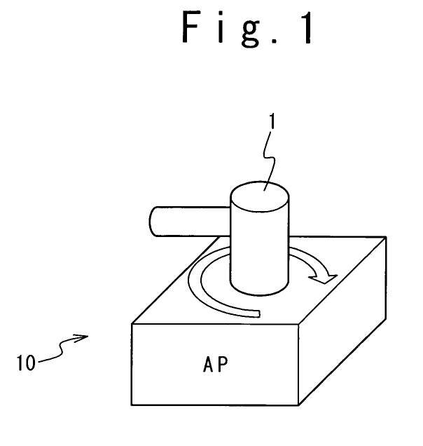

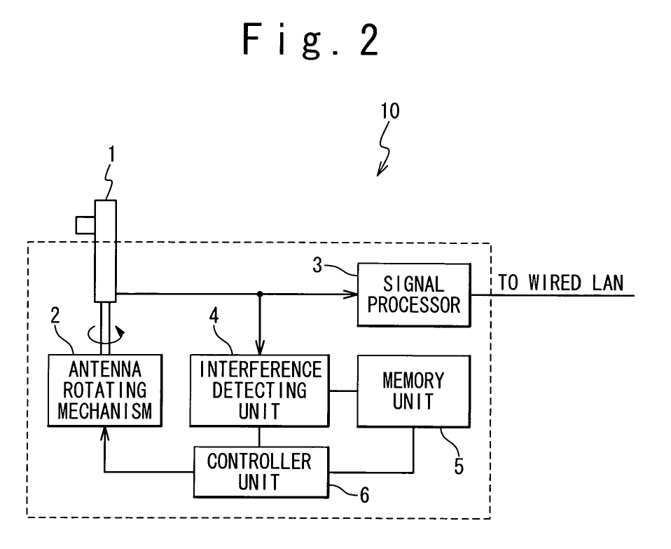

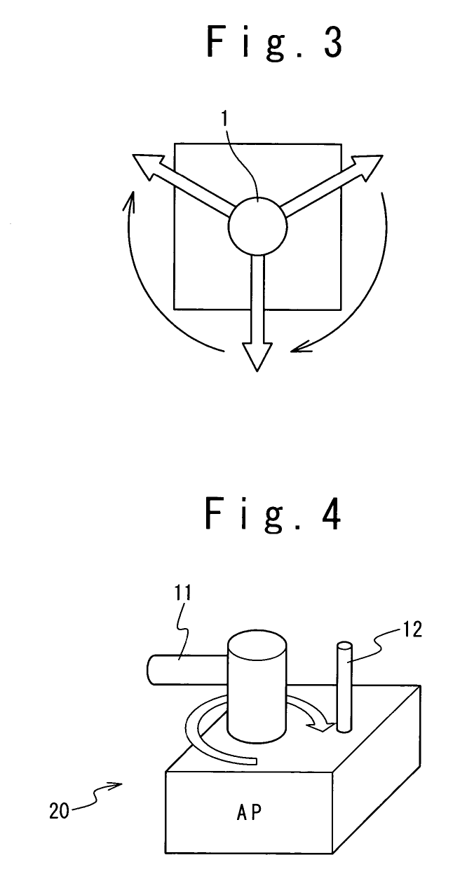

In a first embodiment, as shown in FIG. 1, a wireless LAN access point 10 is provided with a directional antenna 1. As shown in FIG. 2, the directional antenna 1 is coupled to an antenna rotating mechanism 2. The antenna rotating mechanism 2 is adapted to rotate the directional antenna 1, and to thereby adjust the maximum gain direction of the directional antenna 1.

The directional antenna 1 is electrically connected to a signal processor 3. The signal processor 3 communicates with a wireless LAN adapter (not shown) through the directional antenna 1 using the IEEE 802.11 protocols. The signal processor 3 is connected to a wired LAN, and provides accesses to the wired LAN for an electronic apparatus connected to the wireless LAN adapter. A laptop computer exemplifies the electronic apparatus connected to the wireless LAN adapter.

The directional antenna 1 is also connected to an interference detecting unit 4 determining whether the antenna 1 receives interference from another wireless LAN access point(s), and if so, detecting a strength of the interference. The interference detecting unit 4 determines that the antenna 1 receives interference when the wireless LAN access point 10 and the other wireless LAN access point(s) uses the same or adjacent channel in frequency, and the directional antenna 1 of the wireless LAN access point 10 receives wave(s) from the other wireless LAN access point(s). The interference detecting unit 4 stores the detected strength of the interference in a memory unit 5.

The wireless LAN access point 10 further includes a controller unit 6 providing a control signal for the antenna rotating mechanism 2 to optimize the gain maximum direction of the directional antenna 1. As described below, the gain maximum direction of the antenna 1 is determined in response to whether the antenna 1 receives interference from another wireless LAN access point(s) and the strength of the interference.

Below is an explanation of the procedure for controlling the gain maximum direction of the directional 1.

In the event that interference from another wireless LAN access point(s) is not detected by the detecting unit 4, the gain maximum direction of the directional antenna 1 is maintained as it is.

In response to the detection of interference from another wireless LAN access point(s), the interference detecting unit 4 determines the strength of the interference, and stored the determined strength in the memory unit 5. The interference detecting unit 4 then informs the controller unit 6 of the detection of the interference from the other wireless LAN access point(s). In response to the information from the interference detecting unit 4, the controller unit 6 develops a control signal to instruct the antenna rotating mechanism 2 to rotate the directional antenna 1.

In response to the control signal received from the controller unit 6, the antenna rotating mechanism 2 rotates the directional antenna 1 by a predetermined angle.

After the rotation of the antenna 1, the interference detecting unit 4 determines whether the antenna 1 receives interference once again. If the antenna 1 is free from interference, the gain maximum direction of the directional antenna 1 is fixed. If not so, the directional antenna 1 is rotated by the predetermined angle once again, after the strength of the interference is measured and stored in the memory unit 5.

The rotation of the directional antenna 1 is repeatedly executed till the antenna 1 becomes free from interference, or till the antenna 1 is rotated by 360 degrees. Each time the interference is detected, the strength of the interference is stored in the memory unit 5, and this results in that the memory unit 5 contains information on an association of the gain maximum directions of the antenna 1 to the strengths of interference.

When no direction eliminating the interference is found, the controller unit 6 determines an optimized direction minimizing the interference on the basis of the information stored in the memory unit 5. The controller unit 6 then develops a control signal to instruct the antenna rotating mechanism 2 to adjust the gain maximum direction of the directional antenna 1 to the optimized direction.

The aforementioned procedure allows the wireless LAN access point 10 in this embodiment to eliminate or minimize interference from another wireless LAN access point(s).

### SECOND EMBODIMENT

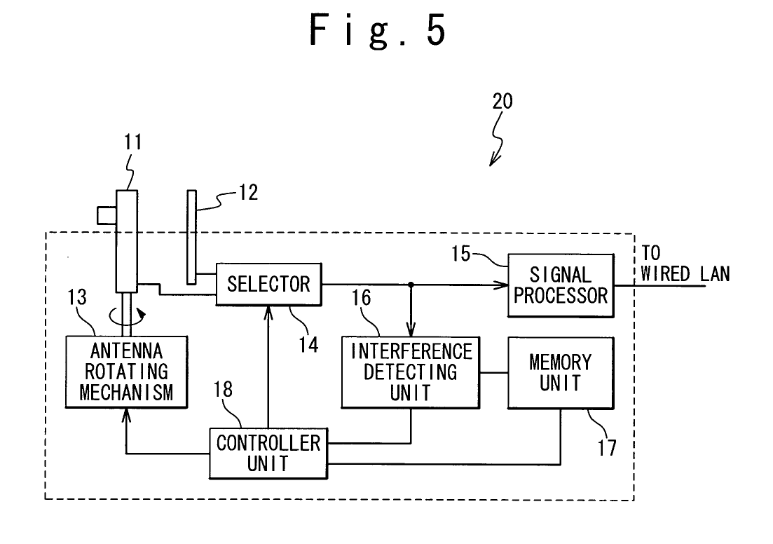

In a second embodiment, as shown in FIG. 4, a wireless LAN access point 20 is provided with a directional antenna 11 and an omnidirectional antenna 12. As shown in FIG. 5, the directional antenna 11 is connected to an antenna rotating mechanism 13 to adjust the gain maximum direction thereof to an optimized direction.

The directional and omnidirectional antenna 11 and 12 are connected to a selector 14. The selector 14 selects one of the directional and omnidirectional antenna 11 and 12, and electrically connects the selected antenna to a signal processor 15.

The signal processor 15 communicates with a wireless LAN adapter (not shown) through the antenna selected by the selector 14 using the IEEE 802.11 protocols. The signal processor 15 is connected to a wired LAN, and provides accesses to the wired LAN for an electronic apparatus connected to the wireless LAN adapter.

The selector 14 is also connected to an interference detecting unit 16 determining whether the selected antenna receives interference from another wireless LAN access point(s) on the basis of a signal receiving from the selector 14, and, if so, detecting a strength of the interference. The interference detecting unit 16 stores the detected strength of the interference in a memory unit 17.

The wireless LAN access point 20 further includes a controller unit 18. The controller unit 18 provides a control signal for the antenna rotating mechanism 13 to adjust the gain maximum direction of the directional antenna 11. As described below, the gain maximum direction is determined in response to whether the directional antenna 11 receives interference from another wireless LAN access point(s) and the strength of the interference. The controller unit 18 is also designed to provide a selector signal for the selector 14 to indicate which antenna is to be selected from among the directional and omnidirectional antennas 11 and 12.

Below is an explanation of the operation of the wireless LAN access point 20 in this embodiment.

In a normal state, the omnidirectional antenna 12, which has a larger communicable area than the directional antenna 11, is selected to achieve communications between the wireless LAN adapter and the signal processor 15. That is, the omnidirectional antenna 12 is electrically connected to the signal processor 15 to allow the signal processor 15 to communicate with the wireless LAN adapter through the omnidirectional antenna 12.

When detecting interference from another wireless LAN access point, the interference detecting unit 16 informs the controller 18 of the detection of the interference. In response to the information from the interference detecting unit 16, the controller unit 18 develops a selector signal to instruct the selector 14 to select the directional antenna 11. In response to the selector signal, the selector 14 disconnects the omnidirectional antenna 12 from the signal processor 15 and the interference detecting unit 16, and connects the directional antenna 11 to the signal processor 15 and the interference detecting unit 16.

The interference detecting, unit 16 then determines whether the directional antenna 11 receives interference from another wireless LAN access point(s).

If the directional antenna 11 is free from interference, the gain maximum direction of the directional antenna 11 is maintained as it is.

If not so, the interference detecting unit 16 stores the strength of the detected interference in the memory unit 17. The interference detecting unit 16 then informs the controller unit 18 of the detection of the interference. In response to the information from the interference detecting unit 16, the controller unit 18 provides a control signal to instruct the antenna rotating mechanism 13 to rotate the directional antenna 11.

In response to the control signal from the controller unit 18, the antenna rotating mechanism 13 rotates the directional antenna 11 by a predetermined angle. After the rotation of the antenna 11, the interference detecting unit 15 determines whether the directional antenna 11 receives interference. If the directional antenna 11 becomes free from interference, the gain maximum direction of the directional antenna 11 is fixed. If not so, the directional antenna 11 is rotated by the predetermined angle once again after the strength of the interference is measured and stored in the memory unit 17.

The rotation of the directional antenna 11 is repeatedly executed till the antenna 11 becomes free from interference or till the antenna 11 is rotated by 360 degrees. Each time the interference is detected, the strength of the interference is stored in the memory unit 17, and this results in that the memory unit 17 contains information on an association of the gain maximum directions of the antenna 11 to the strengths of interference.

When no direction eliminating the interference is found, the controller unit 18 determines an optimized direction minimizing the interference on the basis of the information stored in the memory unit 17. The controller unit 18 then develops a control signal to instruct the antenna rotating mechanism 13 to adjust the gain maximum direction of the directional antenna 11 to the optimized direction.

If a predetermined duration expires after the directional antenna 11 is selected, the selector 14 is automatically switched to select the omnidirectional antenna 12, which has a larger communicable area than the directional antenna 11. This effectively enlarges the communicable area of the wireless LAN access point 20. The selector 14 is preferably adapted to manual operation by users for allowing the selector 14 to select the omnidirectional antenna 11.

The aforementioned procedure allows the wireless LAN access point 20 in this embodiment to eliminate or minimize interference from another wireless LAN access point(s). Furthermore, the wireless LAN access point 20 enjoys a larger communicable area, because the omnidirectional antenna 12 is selected when no interference from another wireless LAN access point is effected.

### THIRD EMBODIMENT

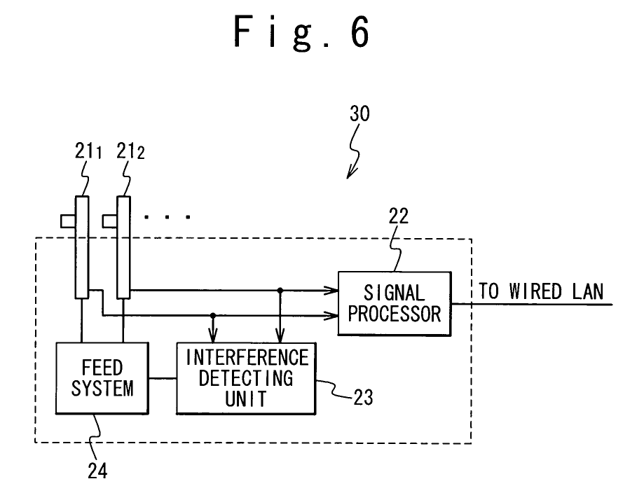

In a third embodiment, as shown in FIG. 6, a wireless LAN access point 30 is provided with a plurality of directional antennas 21 (two shown), which may be distinguished by indexes attached thereto.

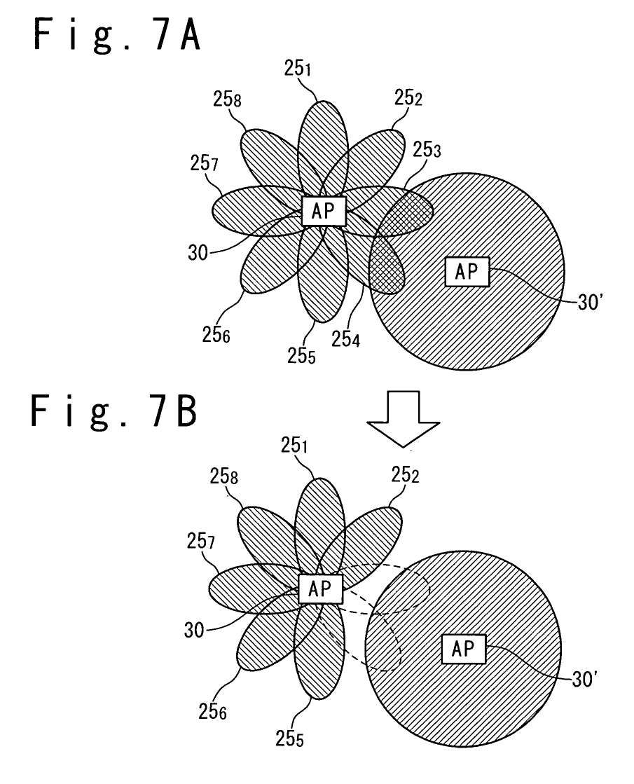

As shown in FIG. 7A, the gain maximum directions of the directional antennas 21₁, 21₂, . . . are different from one another. That is, communicable areas 25₁, 25₂, . . . of the respective directional antennas 21₁, 21₂, . . . have their longitudinal axes in different directions. The gain maximum directions of the directional antennas 21 are determined such that the communicable area of the wireless LAN access point 30 is maximized.

As shown in FIG. 6, the directional antennas 21 are connected to a signal processor 22. The signal processor 22 communicates with a wireless LAN adapter (not shown) through the directional antennas 21 using the IEEE 802.11 protocols. The signal processor 22 is connected to a wired LAN, and provides accesses to the wired LAN for an electronic apparatus connected to the wireless LAN adapter.

The directional antennas 21 are also connected to an interference detecting unit 23 determining whether the respective antennas 21 receive interference from another wireless LAN access point(s). The interference detecting unit 23 develops an interference detection signal representative of the result of the interference detection.

The wireless LAN access point 10 further includes an antenna feed system 24 connected to the directional antennas 21. The antenna feed system 24 is responsive to the interference detection signal from the interference detecting unit 23 for activating or deactivating the directional antennas 21. In response to the interference detection signal, one or more antennas which are free from interference are selected from among the directional antennas 21, and the selected antennas are selectively activated by the feed system 23. The remaining antennas are deactivated by the feed system 23.

FIGS. 7A and 7B illustrate an operation of the wireless LAN access point 30 for avoiding interference from another wireless LAN access point 30′. When the wireless LAN access points 30 and 30′ uses the same or adjacent channel at the same time, as shown in FIG. 7A, one or more of the directional antennas 21 of the wireless LAN access point 30 may receive interference from the wireless LAN access points 30′. In response to the reception of the interference, the feed system 24 stops feeding the directional antenna(s) receiving the interference. This results in that the directional antenna(s) receiving the interference is (are) deactivated. The remaining directional antennas are maintained activated and used to achieve communications between the wireless LAN access point 30 and a wireless LAN adapter. The activated antennas provides communicable areas for the wireless LAN access point 30.

The aforementioned operation effectively avoids the wireless LAN access point 30 receiving interference from another wireless LAN access point, while providing a sufficiently large communicable area for the wireless LAN access point 30.

### FOURTH EMBODIMENT

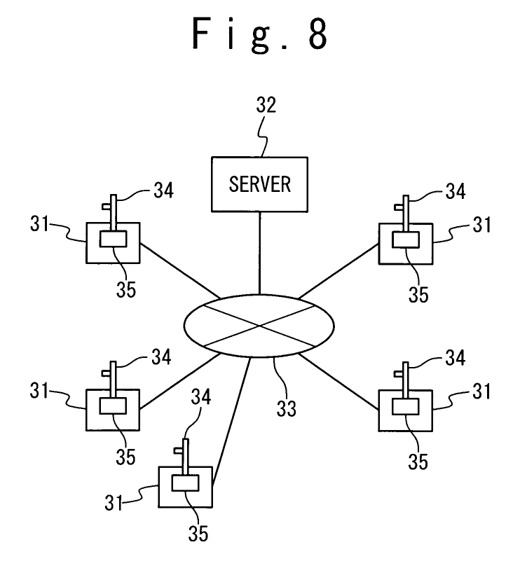

In a fourth embodiment, as shown in FIG. 8, a wireless LAN system is provided with a plurality of wireless LAN access points 31, and a server 32 connected to the wireless LAN access points 31 through a wired LAN 33.

Each of the wireless LAN access points 31 is provided with a directional antenna 34 and a antenna rotating mechanism 35. The directional antenna 34 is used to communicate with a wireless LAN adapter (not shown). The antenna rotating mechanism 35 is adapted to rotate the directional antenna 34 to adjust the gain maximum direction of the directional antenna 34.

The server 32 selects one of the channels for the each wireless LAN access point 31, the one which is to be used by the each wireless LAN access point 31 for communications with an associated wireless LAN adapter.

In addition, the server 32 controls the gain maximum direction of the each directional antenna 34. The server 32 determines a proposed gain maximum direction of the each directional antenna 34, and controls the antenna rotating mechanism 35 of the each wireless LAN access point 31 through the wired LAN 33 to adjust the gain maximum direction of the each directional antenna 34 to the proposed direction.

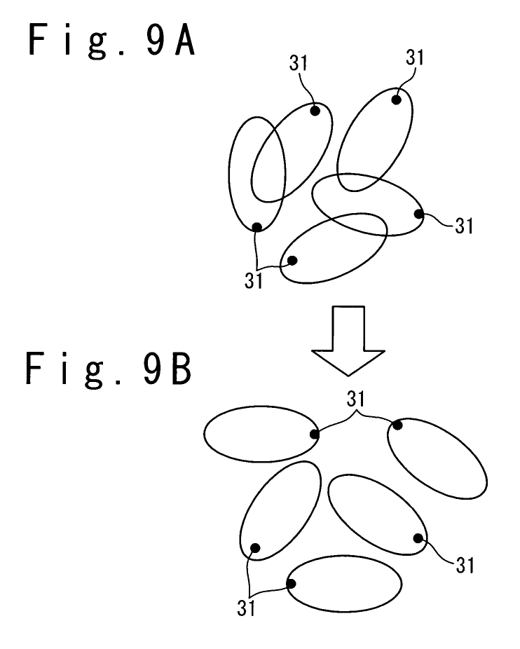

Below is a description of the procedure for determining the proposed direction for the each directional antenna 34. The process begins with obtaining information on the communicable areas of the respective wireless LAN access points 31, and information on the communication channels used by the respective wireless LAN access points 31. The server 32 then determines the communication channel and the proposed gain maximum direction for the each wireless LAN access point 31. As shown in FIG. 9, the server 32 determines the communication channel and the proposed gain maximum direction such that the wireless LAN access points using the same or adjacent channel do not have their communicable areas overlapped each other. Although FIG. 9 shows such an arrangement that the communicable areas of the wireless LAN access points 34 are not overlapped each other, it should be understood that the communicable areas of the wireless LAN access points using communication channels which does not interfere each other are allowed to be overlapped each other. It is advantageous, however, if the communicable areas of the wireless LAN access points 31 are not overlapped each other to enlarge the communicable area of the whole wireless LAN system.

As described above, the wireless LAN system in this embodiment effectively avoids interference between or among the wireless LAN access points.

In addition, the wireless LAN system achieves an enlarged communicable area through the control of the gain maximum direction of the each directional antennas 34 and the communication channel used by the each wireless LAN access point 31.

### FIFTH EMBODIMENT

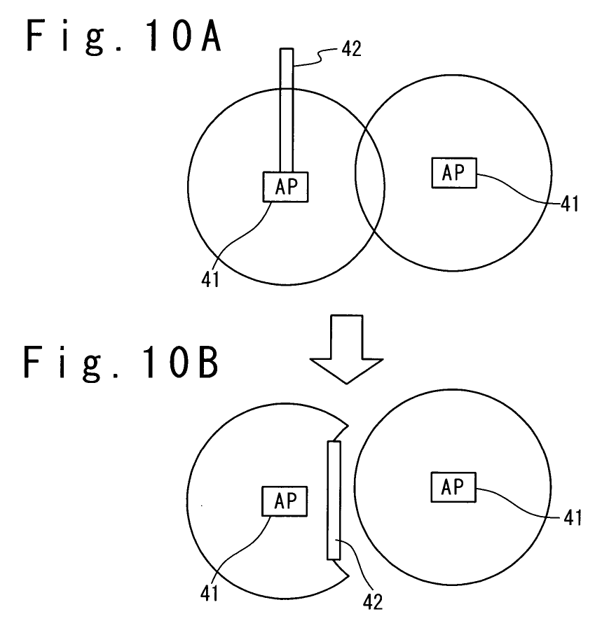

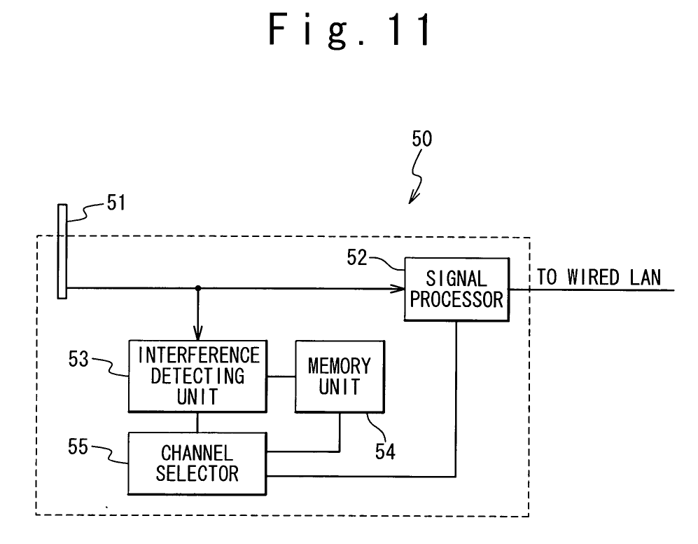

In a fifth embodiment, as shown in FIG. 10, a wireless LAN system is provided with wireless LAN access points 41 and a shield plate 42, and a mechanism for controlling the posture of the shield plate 42. The shield plate 42 is made from a conductive shielding material (such as metal) to substantially completely block electromagnetic waves emitted from the wireless LAN access points 41.

The shield plate 42 is positioned and postured in response to occurrence of interference between the wireless LAN access points 41. When the wireless LAN access points 41 do not interfere with each other, the shield plate 42 is positioned and postured so that the main surface of the shield plate 42 is parallel to the radial direction in which one of the wireless LAN access points 41 emits the electromagnetic wave. This prevents the shield plate 42 from reducing the communicable area of the wireless LAN access points 41. Instead, the shield plate 42 may be laid down to a floor.

When the wireless LAN access points 41 interfere with each other as shown in FIG. 10A, on the other hand, the shield plate 42 is moved to be positioned between the wireless LAN access points 41. The position and posture of the shield plate 42 are regulated so that the interference between the wireless LAN access points 41 is eliminated or minimized.

As thus-described, the use of the shield plate 42 effectively eliminates or reduces the interference between the wireless LAN access points 41.

Furthermore, in the event that the wireless LAN access points 41 do not interfere with each other, the shield plate 42 is postured so that the main surface of the shield plate 42 is parallel to the radial direction, or laid down to the floor. This effectively avoids the communicable area of the wireless LAN access points 41 being undesirably reduced.

### SIXTH EMBODIMENT

In a sixth embodiment, a wireless LAN access point 50 includes an omnidirectional antenna 51, and a signal processor 52. The omnidirectional antenna 51 is connected to the signal processor 52.

The signal processor 52 communicates with a wireless LAN adapter (not shown) through the omnidirectional antenna 51 using the IEEE 802.11 protocols. As mentioned above, the IEEE 802.11 protocols allows the wireless LAN system to use 14 channels. The channels are identified by channel numbers.

The signal processor 52 is connected to a wired LAN (not shown) to provides accesses to the wired LAN for an electronic apparatus in which the wireless LAN adapter is installed.

The omnidirectional antenna 51 is also connected to an interference detecting unit 53. The interference detecting unit 52 determines whether the omnidirectional antenna 51 receives interference from another wireless LAN access point(s), and if so, detects a strength of the interference. When the wireless LAN access point 50 and another wireless LAN access point use the same or adjacent channel, and the omnidirectional antenna 51 receives a wave from the other wireless LAN access point, the interference detecting unit 53 determines that the omnidirectional antenna 51 receives the interference from the other wireless LAN access point. The interference detecting unit 51 stores the detected strength of the interference in a memory unit 54.

The interference detecting unit 53 is connected to a channel selector 55. The channel selector 55 is responsive to occurrence of the interference and the strength thereof for selecting one of the 14 available channels. The channel selector 55 provides the signal processor 52 with information representative of the selected channel. The signal processor 52 communicates with the wireless LAN adapter through the channel selected by the channel selector 55.

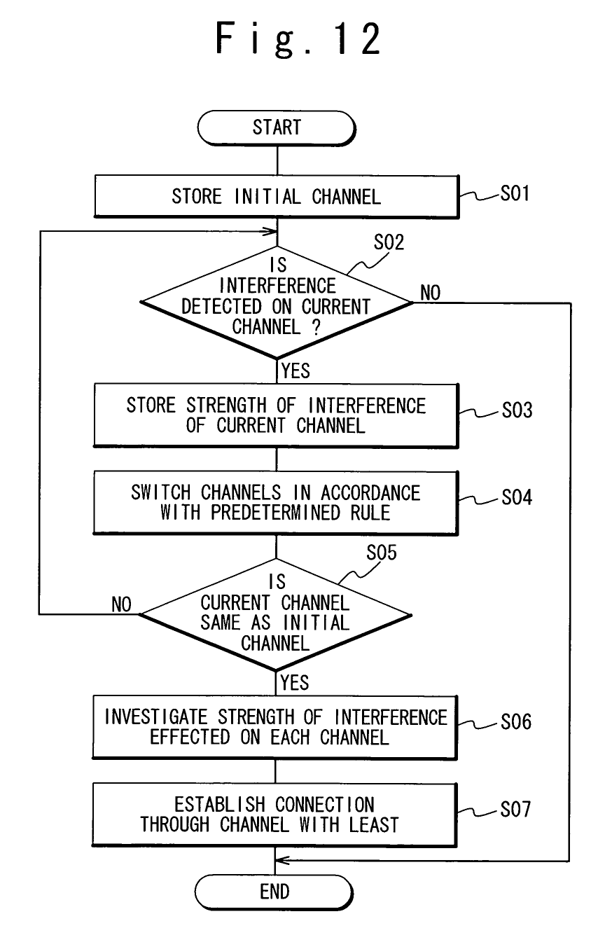

FIG. 12 is a flowchart illustrating an operation of the wireless LAN access point 50 in this embodiment. The wireless LAN access point 50 repeatedly executes the operation illustrated in FIG. 12.

The procedure begins with storing the channel number of the initial channel in the memory unit 54. The initial channel implies the channel currently selected by the channel selector at Step S01.

The interference detecting unit 53 then determines whether the current channel suffers from interference from another wireless LAN access point at Step S02. If the interference detecting unit 53 determines that the current channel is free from interference, the signal processor 52 continues using the current channel to achieve communications with the wireless LAN adapter.

If the interference detecting unit 53 detects occurrence of interference at Step S02, the strength of the interference is detected, and information representative of the detected strength of the interference and the current channel is stored in the memory unit 54 at Step S03.

Then, the next channel to be used is selected by in accordance with a predetermined regulation at Step S04. For example, the channel selector 52 selects a channel having the channel number equal to the current channel number increased by 2 as the next channel if the current channel number increased by 2 is equal to or less than the maximum channel number. If not so, the channel selector 52 selects a channel having the minimum channel number as the next channel.

When the channel number of the selected channel is not identical to that of the initial channel, the procedure is skipped to Step S02. When the selected channel is free from interference, the selected channel is used to achieve communications with the associated wireless LAN adapter. Otherwise, Steps S03 to S05 are repeated to store the strength of interference, and select another channel to be used.

When the channel selected at Step S04 is identical to that of the initial channel, this implies that all the channels suffer from interference. In this case, the channel selector 54 selects the channel minimizing the interference on the basis of the information on the strengths of the interference stored in the memory unit 54 at Step S06. At step S07, the communication channel is then switched to the interference-minimizing channel.

The aforementioned operation effectively reduces interference effected on the wireless LAN access point 50 by another wireless LAN access point. Furthermore, the operation of the wireless LAN access point 50 in this embodiment does not require modification of the communicable area thereof. This allows the wireless LAN access point 50 to use an omnidirectional antenna 51, which has an advantage of a wide communicable area.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

What is claimed is:

1. A wireless LAN access point comprising:
a directional antenna;
an interference detector detecting interference effected by another wireless LAN access point on said directional antenna; and
a direction adjusting mechanism adjusting a maximum gain direction of said directional antenna in response to said detected interference.

2. The wireless LAN access point according to claim 1, further comprising a control unit determining an optimized direction in response to the detected interference,
wherein said direction adjusting mechanism adjusts a maximum gain direction of the directional antenna to the optimized direction, and
wherein said control unit determines said optimized direction such that said directional antenna is free from said interference effected by said other wireless LAN access point.

3. The wireless LAN access point according to claim 2, wherein said interference detector detects a strength of said interference from said other wireless LAN access points, and
wherein said controller unit determines said optimized direction in response to said detected strength of said interference.

4. A wireless LAN access point comprising:
a directional antenna;
an omnidirectional antenna;
a signal processor;
a selector unit selecting one of said directional antenna and said omnidirectional antenna in response to interference from other wireless LAN access points, wherein said selector unit provides electrical connections between said signal processor and said selected antenna,
wherein said signal processor receives and transmits radio signals through said selected antenna.

5. The wireless LAN access point according to claim 4, further comprising an interference detector detecting said interference, and
wherein, in response to detection of said interference during reception and transmission of said radio signals through said omnidirectional antenna, said selector unit disconnects said omnidirectional antenna from said signal processor, and connects said directional antenna to said signal processor.

6. The wireless LAN access point according to claim 5, further comprising:
a controller unit determining an optimized direction in response to a strength of said interference; and
a direction adjusting mechanism adjusting an maximum gain direction of said directional antenna to said optimized direction.

7. A wireless LAN access point comprising:
a plurality of directional antennas having different maximum gain directions;
an antenna controller adapted to activate and deactivate said plurality of directional antennas; and
an interference detecting unit detecting interference effected by other wireless LAN access point on said plurality of directional antennas,
wherein said antenna controller deactivates one of said plurality of directional antennas on which said interference is effected, while activating another of said plurality of directional antennas which is free from said interference.

8. A wireless LAN system comprising:
a plurality of wireless LAN access points, each of which includes:
a directional antenna, and
a direction adjusting mechanism connected to said directional antenna; and
an antenna controller determining an optimum direction of each of said directional antennas,
wherein each of said direction adjusting mechanisms adjusts a maximum gain direction of said directional antennas associated therewith to said optimum direction determined by said antenna controller.

9. The wireless LAN system according to claim 8, wherein said antenna controller determines said optimum directions of said directional antennas such that communicable areas of said plurality of wireless LAN access points do not overlap one another.

10. A wireless LAN access point comprising:
an interference detector detecting interference effected by other wireless LAN access points;
a channel selector switching a plurality of channels used to communicate with a terminal; and
a signal processor,
wherein, in response to detection of interference on one of said plurality of channels during communications through said one channel, said channel selector selects another channel from among said plurality of channels which receives least interference from said other wireless LAN access points, and
wherein said signal processor communicates with said terminal through said selected channel.

11. A method for avoiding interference between wireless LAN access points, comprising:
detecting interference between first and second wireless LAN access points; and
moving an electromagnetic shield between said first and second wireless LAN access points in response to occurrence of said interference.

12. The method according to claim 11, wherein said electromagnetic shield includes a shield plate, and said method further comprises:
arranging said shield plate such that a main surface of said shield plate is parallel to a direction of an electromagnetic wave from said first wireless LAN access point in response to nonoccurrence of said interference.

13. The method according to claim 11, wherein said electromagnetic shield includes a shield plate, and said method further comprises:
laying down said shield plate onto a floor in response to nonoccurrence of said interference.

14. A method for operating a wireless LAN access point including a directional antenna, said method comprising:
detecting interference effected on said directional antenna by another wireless LAN access point;
determining an optimized direction in response to said detected interference; and
adjusting a gain maximum direction to said optimized direction so that said directional antenna is free from said interference.

15. A method for operating a wireless LAN access point including a directional antenna, said method comprising:
detecting a strength of interference effected on said directional antenna by another wireless LAN access point;
determining an optimized direction in response to said detected strength of said interference; and
adjusting a gain maximum direction to said optimized direction.

16. A method for operating a wireless LAN access point including directional and omnidirectional antennas, said method comprising:
selecting one of said directional and omnidirectional antennas; said selected one being to be used for communications, wherein said directional antenna is selected in response to detection of interference from another wireless LAN access point during use of said omnidirectional antenna.

17. The method according to claim 16, further comprising:
determining an optimized direction in response to a strength of said interference; and
adjusting a gain maximum direction of said directional antenna to said optimized direction.

18. A method for operating a wireless LAN access point including a plurality of directional antennas having different gain maximum directions, said method comprising:
determining whether said plurality of directional antennas respectively receive interference from another wireless LAN access point;
deactivating one(s) of said plurality of said directional antennas; said one(s) receiving said interference; and
achieving communications through remaining one(s) of said plurality of said directional antennas.

19. A method for operating a wireless LAN access point adapted to communicate with a wireless LAN adapter through a plurality of channels, said method comprising:
detecting interference from another wireless LAN access point;
selecting one channel from among said plurality of said channels so that said selected channel eliminates or minimizes said interference; and
achieving communications with said wireless LAN adapter through said selected channel.
